(19) United States
(12) Patent Application Publication
(10) Pub. No.: US 2008/0196789 A1
(43) Pub. Date: Aug. 21, 2008

(54) Device for Feeding Sealing Liquid into a Tire

(75) Inventor: Eduard Hartl, Besigheim (DE)

Correspondence Address: GUDRUN E. HUCKETT DRAUDT, SCHUBERTSTR. 15A, WUPPERTAL, 42289, omitted

(73) Assignee: PREMIUM VERTRIEBS GMBH, Besigheim (DE)

(21) Appl. No.: 11/917,832

(22) PCT Filed: Jun. 16, 2006
(86) PCT No.: PCT/EP06/05811

§ 371 Date: Dec. 17, 2007

(30) Foreign Application Priority Data
Jun. 17, 2005 (DE) 10 2005 028 257.1

(51) Int. Cl. B60C 25/00

(52) U.S. Cl. 141/38

(57) ABSTRACT

A device for supplying sealing liquid into a tire has a connecting flange that can be attached to a valve of a tire. An essentially cylindrical housing is arranged on the connecting flange, wherein the cylindrical housing has a connector for supplying the sealing liquid and a hollow space extending at least from the connector to the connecting flange. A valve screwdriver is arranged in the cylindrical housing so as to be movable in an axial direction of the cylindrical housing, wherein the valve screwdriver has a receptacle for detachably connecting the valve screwdriver to a valve insert of the valve of the tire such that the valve insert is removable by the valve screwdriver in the axial direction when the sealing liquid is to be supplied into the tire. The device for supplying sealing liquid as a whole has an ergonomic and essentially elongate cylindrical shape.

The invention relates to a device for feeding sealing liquid into a tire.

Such a device is disclosed in U.S. Pat. No. 5,960,836. This publication discloses a device with which a sealing liquid as well as a compensation liquid can be introduced into a pneumatic tire. For this purpose, valve devices are provided on the tire and are connected by a hose connection to a container and, by means of the hose connection, supply liquid or compressed air to the tire.

U.S. Pat. No. 4,308,766 discloses a device that can be placed onto a tire valve and that allows liquid to be pumped from a reservoir into a tire. In this device, by an appropriate mechanic means, the tire valve is removed and the liquid can flow in unhindered. A disadvantage of this device is that it requires a large working space that, in particular, is not available on a tire valve or only available to an unsatisfactory degree. Moreover, further disadvantages are the unfavorable arrangement of a supply hose and a complex manipulation.

Moreover, German utility model 29812740 discloses a repair kit with a portable container. This repair kit can also be suitable for introducing a sealing medium into a vehicle tire. For this purpose, the repair kit is designed such that it can be stored in a spare wheel.

A disadvantage of the known devices for sealing defective tires resides in that the sealing medium does not closed off only the site to be sealed but also leads to plugging or impairment of the tire valve.

Based on the examination results of different tire defects, it was found that sealing medium residues on the valve seat cause slight leaks and a creeping pressure loss with significant impairment of the driving behavior of the vehicle; in particular, the creeping loss of air leads to a reduction of the driving stability of the vehicle and also to increased tire heating so that a further defect or a complete loss of the tire can occur.

It is an object of the invention to avoid the aforementioned disadvantages and to provide a device for supplying sealing liquid into a tire that ensures a high seal-tightness of the tire, that does not lead to plugging of the valve, and that can be handled easily.

This object is solved by the features of the independent claim 1.

The important advantage of the invention resides in that the device is provided with a valve screwdriver with which, before introduction of the sealing liquid, the valve insert can be removed so that the sealing liquid can flow unimpaired into the tire. Moreover, the entire device has an ergonomically designed shape, is therefore easy to handle, and, as a result of the inventive elongate cylindrical shape, also useable at locations that are not easily accessible.

According to one embodiment of the invention, the connection for supplying the sealing liquid is arranged essentially such that the liquid can flow unhindered into the tire. This means that no or only a minimal deflection of the liquid of less than 45 degrees takes place.

For connecting the device to the tire valve, according to a further embodiment of the invention, the connecting flange is provided with a locking device. The locking element has a spring and is placed onto the outer thread of the valve. By means of this outer thread, a positive-locking connection is provided so that accidental release of the device from the valve is impossible.

According to a further embodiment, the valve screwdriver is provided with a turning grip and is axially displaceably arranged on the cylindrical housing. This simplifies turning and removing the inner part of the valve, i.e., the valve insert, from the immediate liquid flow. According to another embodiment of the invention, the device is connected to a liquid container. This connection is realized by means of a hose. The liquid container is a pressure-stable container and is supplied with compressed air by a compressor. By means of this pressure build-up it is ensured that—upon activation of the entire device—the sealing liquid is supplied to the tire. Subsequently, the tire is pumped up with compressed air to the desired pressure. For a compact arrangement of the entire system, on the outer structure of the liquid container a receptacle for the hose and the device for supplying the sealing liquid are provided.

According to another embodiment, this receptacle can be a locking or plug-in connection so that the hose or the device can be easily removed. On the other hand, the container itself can be provided on its exterior side in a preferred way with a device for detachable attachment so that it can be locked on a vehicle or a vehicle part.

According to one embodiment of the invention for supplying sealing liquid, the container for the sealing liquid is comprised of a pressure-resistant plastic material. On the container opening, a screw lid is provided that has a discharge device wherein an immersion pipe is arranged thereat that extends to the bottom of the container or is axially movably arranged in the screw lid.

When filling a tire with the sealing liquid, the container can be in an upright position. Through the immersion pipe the liquid is conveyed upwardly until the container is empty and is discharged by overpressure that is generated by an external overpressure source in the container or is present within the container.

The immersion pipe can be provided for discharging the liquid but it can however also be used for supplying compressed air. In this case, the container is essentially placed on its head, i.e., is placed with the screw lid onto a support. The liquid is discharged from the container in the area of the screw lid through an additional discharge opening.

Inasmuch as the immersion pipe is designed for supplying compressed air, a check valve can be arranged therein in order to prevent discharge of liquid through the compressed air supply line.

Inasmuch as the compressed air is not supplied in the area of the screw lid, according to one embodiment of the invention on the side of the container opposite the screw lid a valve or an opening for supplying compressed air can be provided. Of course, there is also the possibility to arrange this valve laterally on the container or at an appropriate location.

These and further features of the invention can be taken not only from the claims but also from the description and the drawings.

The invention will be explained in the following with the aid of embodiments in more detail.

It is shown in:

FIG. 1 a perspective illustration of a device for supplying a sealing liquid to a tire;

FIG. 2 a section illustration of the device according to FIG. 1 in an initial position for opening the valve;

FIG. 3 a further section illustration in a position with open valve;

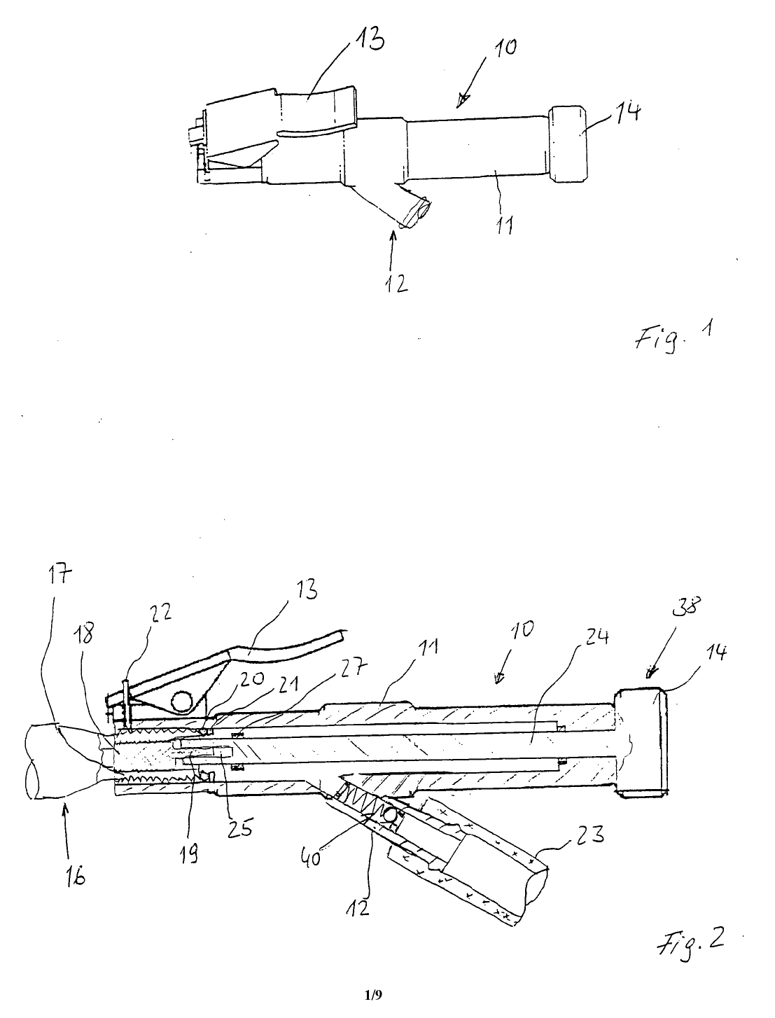

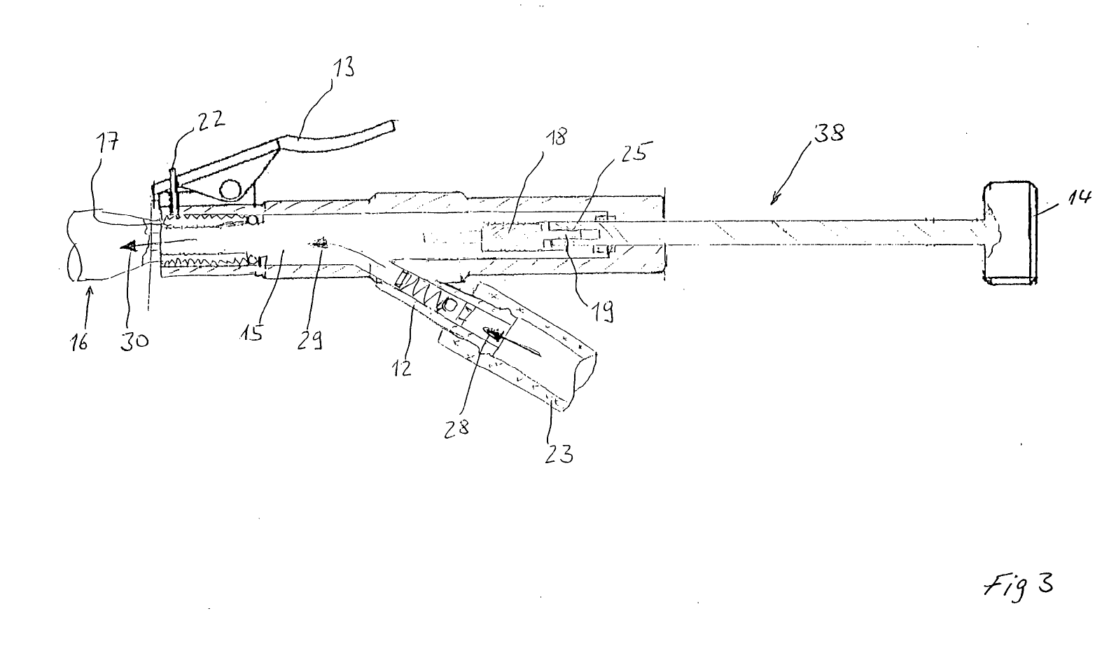

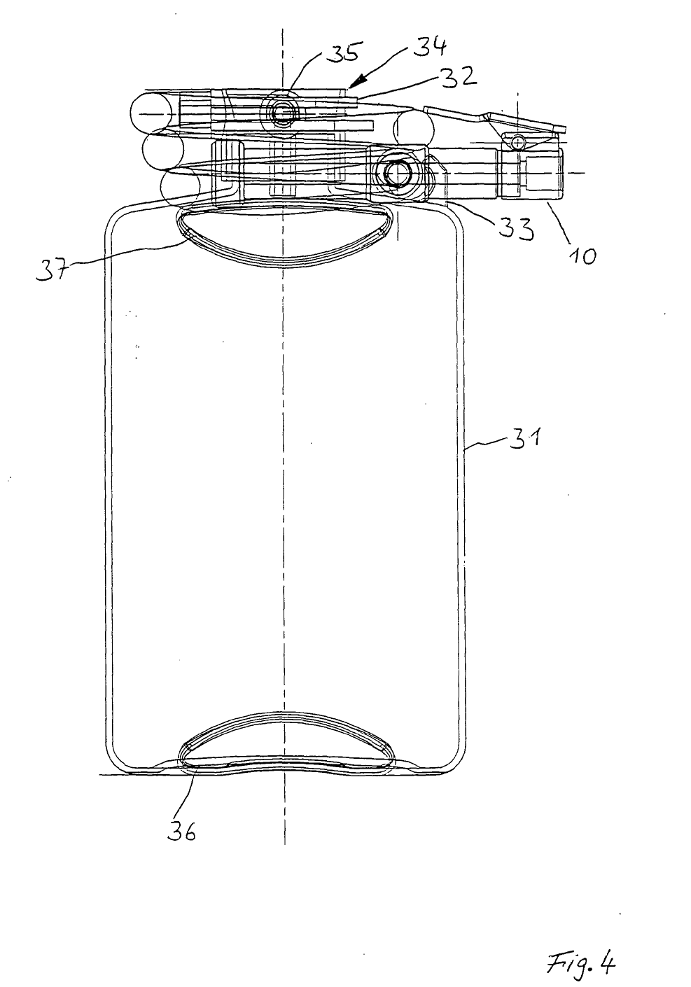

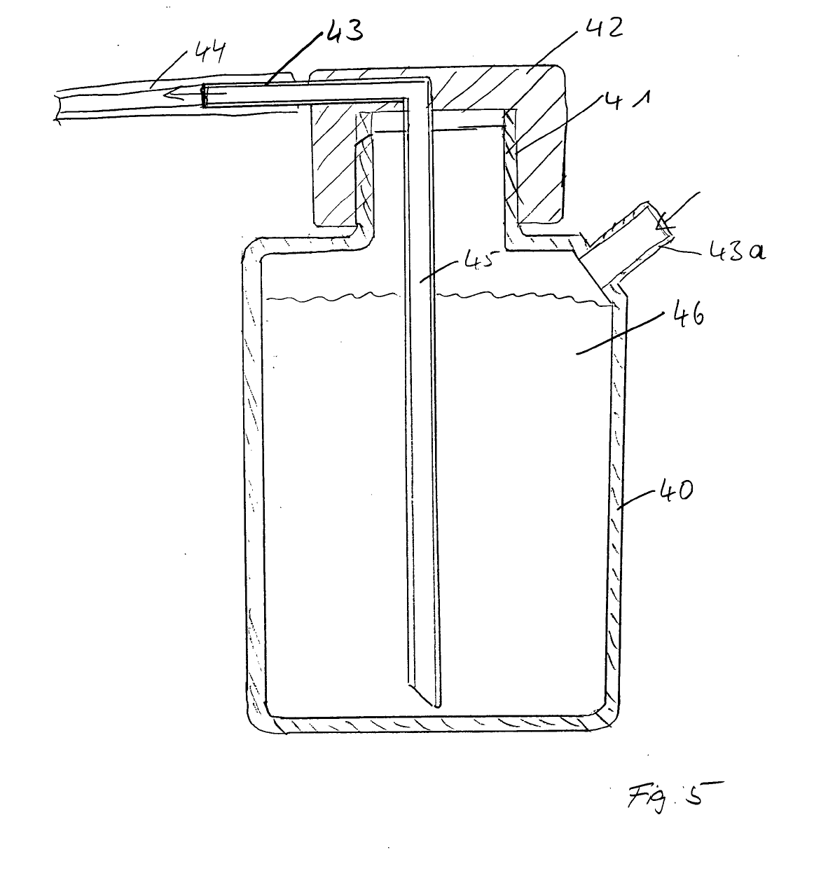

FIG. 4 an external view of a container with adapted filling device;

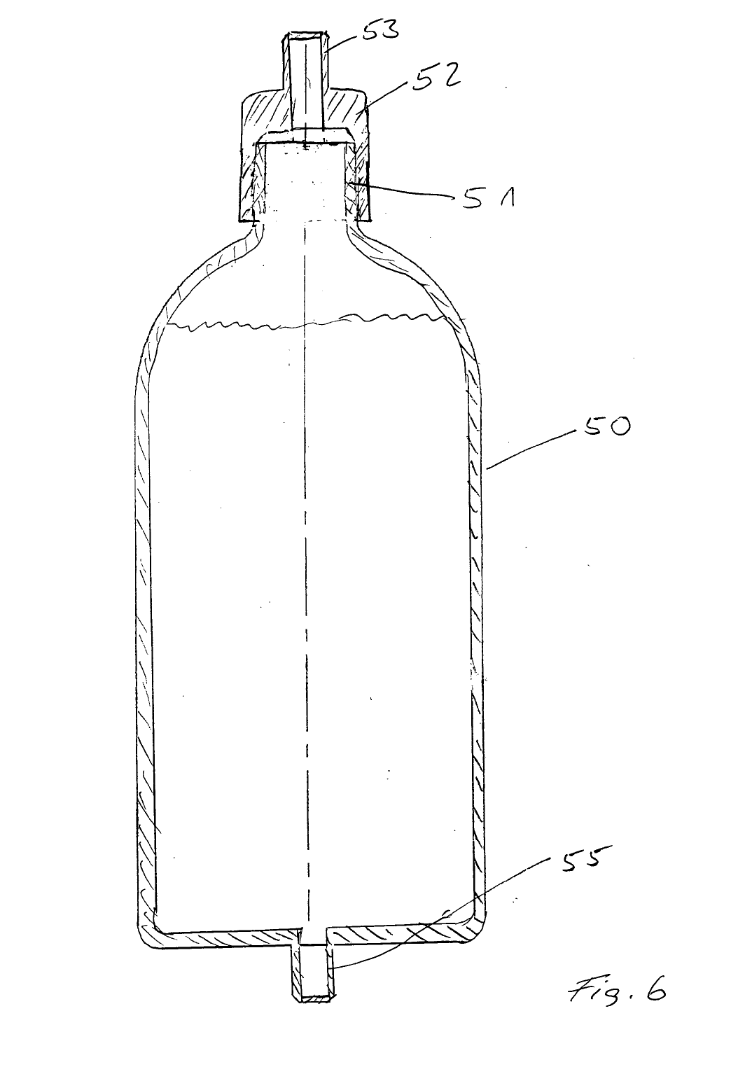

FIG. 5 a container for sealing liquid in a schematic illustration with an immersion pipe;

FIG. 6 a container for sealing liquid in a schematic illustration as a variant of FIG. 5;

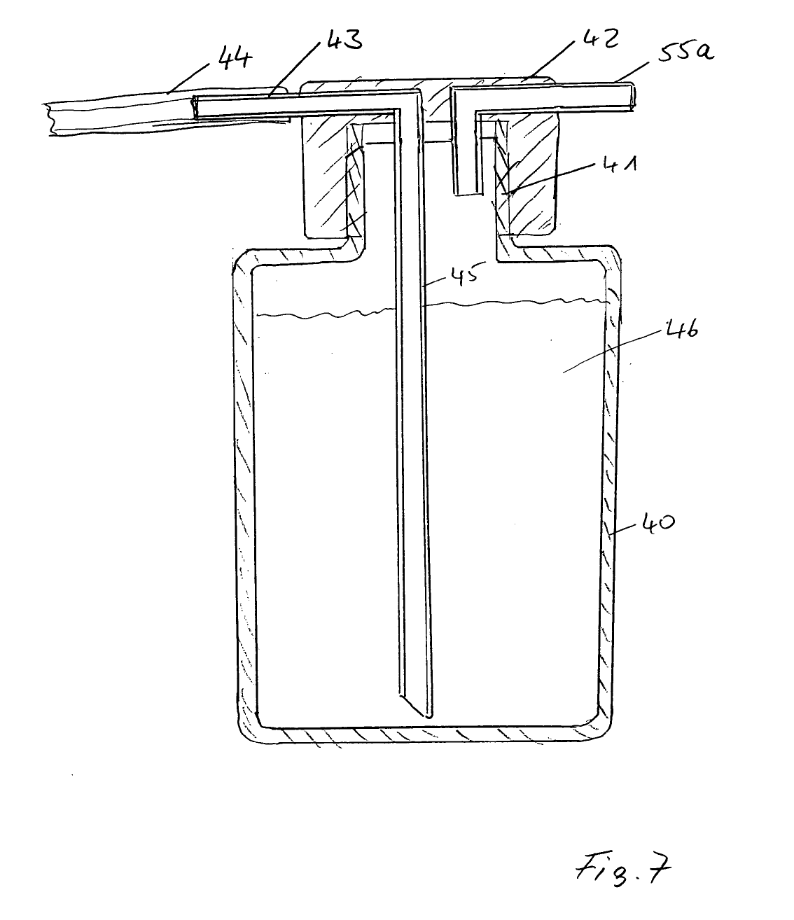

FIG. 7 a further variant of the container illustrated in FIG. 5 for sealing liquid;

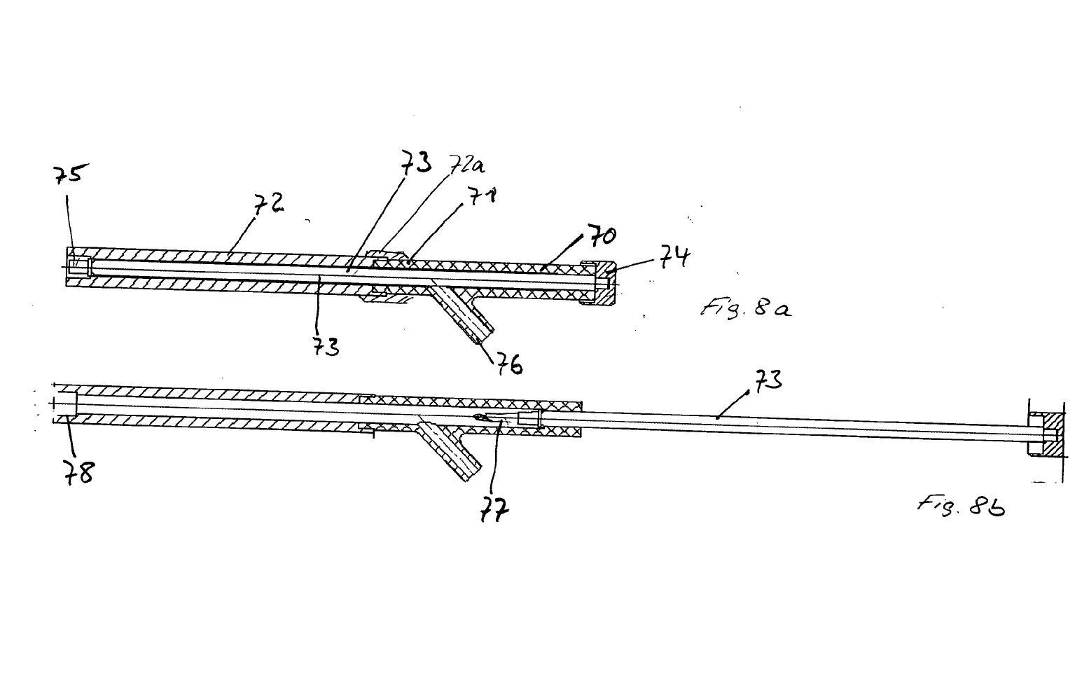

FIG. 8a and b a device for supplying sealing liquid in an extended version;

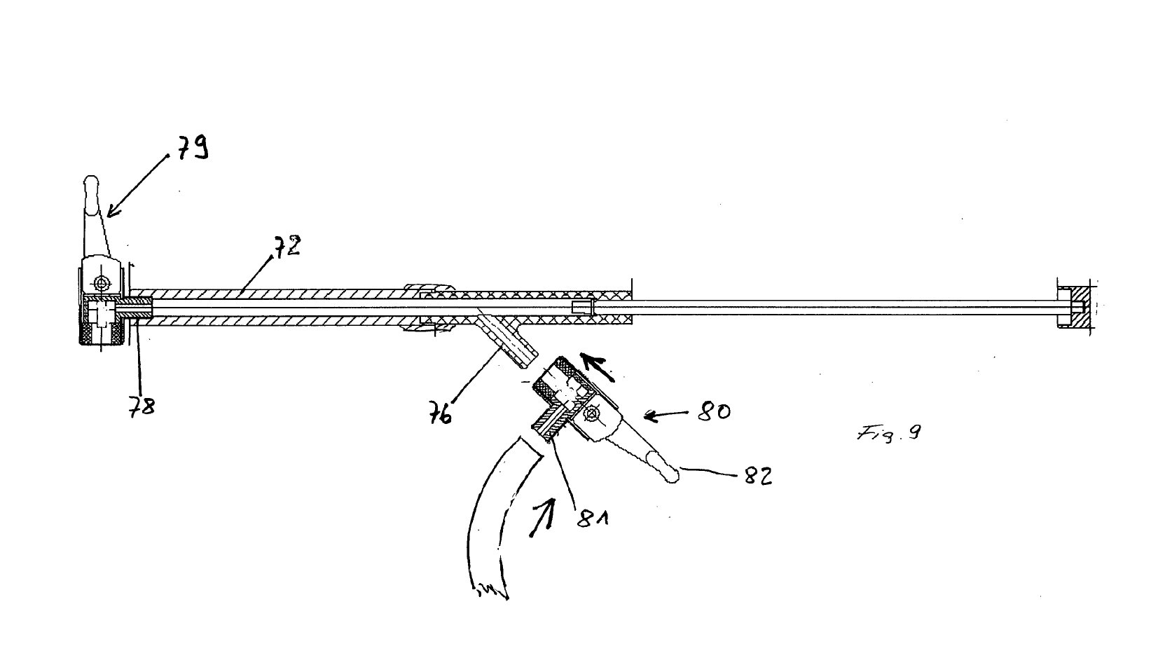

FIG. 9a device for supplying a sealing liquid with a plug-in nipple lever;

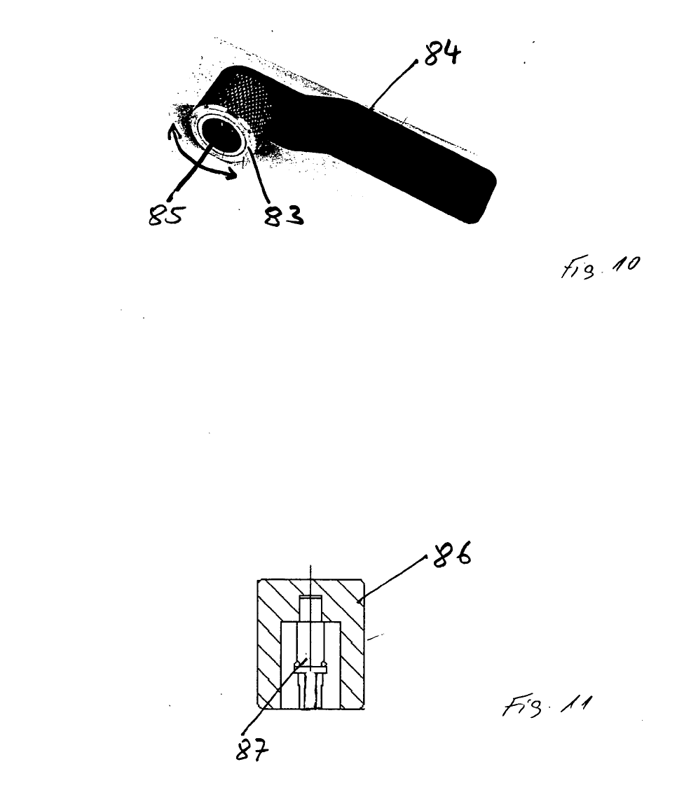

FIG. 10a variant of the valve screwdriver

FIG. 11a miniature configuration of the valve driver.

In the perspective illustration according to FIG. 1 a filling device 10 is illustrated, i.e., with this manual device a sealing liquid can be supplied to a tire. This manual device has a housing 11 on which a connecting socket 12 for supplying sealing liquid is arranged. This connecting socket extends at an angle of approximately 30-60 degrees relative to the longitudinal axis of the filling device 10 into the latter so that the supplied liquid is subjected to only a minimal flow deflection.

The left area of the filling device 10 is provided with an actuating element 13. The latter will be explained in more detail in the following. On the opposite end of the filling device 10, there is a valve screwdriver with a grip 14; its function will also be explained later.

The entire filling device 10 is ergonomically designed; because of its slim elongate cylindrical shape it is easy to handle and can be connected to valves that are not easily accessible.

In the section illustration according to FIG. 2, the filling device 10 is shown again. Same parts are referenced with same reference numerals. Within the housing 11 there is a hollow space 15 that is essentially cylindrical. In the shown illustration, a valve 16 of a conventional tire is already inserted into the forward end of the filling device. As is known in the art, this valve has a shaft 17 into which a valve body 18 or valve insert is screwed. The valve body has conventionally a valve pin as well as a valve spring and a valve plate. The valve body 18 has at its outwardly extending end a flat section that enables unscrewing of the valve body 18 from the shaft 17.

Within the filling device 10, there is a sealing ring 20 that rests against a stop 21. This sealing ring and the forward end face of the valve body 18 together provide the sealing action of the valve. For locking the valve 16 in the filling device 10, there is a locking element 22 in the form of a slide. This locking element is moved by a spring, not illustrated, onto the outer thread of the shaft so that a positive-locking connection between filling device 10 and valve 16 results.

The locking element 22 can be pulled outwardly by means of the actuating element 13 that is embodied as a rocker lever for releasing the connection between filling device 10 and the valve 16. On the connecting socket 12 there is a hose 23 that extends to a liquid container, not illustrated. At the grip 14 of the valve screwdriver there is an actuating rod 24. This actuating rod has a slot 25 that serves for receiving the flat section 19. In the illustrated embodiment, this slot 25 extends across the flat sections so that by means of the grip 14 unscrewing of the valve body 18 is possible. The advantage of this slot is the design in the form of a gripping arm that makes it possible to unscrew differently shaped valve inserts from the valve.

For sealing the hollow space 15 in the area where the actuating rod 24 passes through the housing 11, there is a profiled or O-ring seal 26. On the actuating rod 24 there is also a longitudinal stop 27. Within the connecting socket there is a check valve 40. It is comprised of a valve ball that is secured by a spring and is supported on a valve seat. By means of the valve a retroaction of the pressure existing in the tire is prevented.

In order for the sealing liquid to pass through the hose 23 to the tire, it may be necessary to first unscrew by means of the grip 14 and the valve screwdriver the valve body 18 from the valve 16 and to subsequently remove it from the valve 16. This is illustrated in FIG. 3. FIG. 3 shows in a section illustration the already open valve. The valve body 18 is located in the rearward area of the hollow space 15 and thus releases the hollow space for introducing the sealing liquid through the hose 23. The sealing liquid flows according to arrows 28, 29, 30 into the tire. Moreover, the compressed air required for filling the sealed tire flows according to the arrows into the tire until the operating pressure of the tire has been reached. Already after filling with sealing liquid and still during filling of the tire with compressed air, the valve body 18 can be moved forwardly and screwed again into the valve 16. This has the advantage that liquid possibly adhering to the valve is entrained by the compressed air, the valve body is essentially flushed with air and, of course, can again fulfill the valve function for the tire.

Once the operating pressure has been reached, the positive-locking connection of the filling device 10 at the valve 16 is released. The filling device 10 is removed again and the sealed tire is fully functional.

A compact arrangement of a complete system with a liquid container is illustrated in FIG. 4. In this external view of the liquid container 31, on the upper area a receptacle 32 for the hose and the device for supplying the sealing liquid are provided. This receptacle 32 has a locking connection 33 to which filling device 10 is adaptable. The hose is wound in a simple way about the head 34 of the container. On this head of the container there is, on the one hand, the connector 35 for the hose and, on the other hand, a further connector, not illustrated here, for connecting a compressor unit to the container.

On the exterior side of the container there is a device in the form of one or two tabs 36, 37 for detachably attaching the container to the vehicle. In this way, the container is precisely positioned in the vehicle and can be removed from its holding device in a simple way for supplying the sealing liquid to the tire.

The container 40 illustrated in FIG. 5 has a connecting socket 41 with a thread. On this connecting socket, a screw lid 42 is provided on which a connector 43 for a supply hose 44 is provided. On the screw lid 42 an immersion pipe 45 is provided that has a connection to the connector 43. Moreover, on the container 40 there is a valve or a connector 43a for supplying compressed air. This connector and, if needed, the connector 43 is closed by a metal plate, for example, an aluminum plate that must be punctured for activating the connector.

In the container there is a sealing liquid 46. Inasmuch as compressed air is supplied to the container through connector 43a, the sealing liquid 46 is discharged through the immersion pipe 45 and the connector 43 and is supplied by means of supply hose 44 to the valve of a tire.

FIG. 6 shows a container 50 that has on its top side a connecting socket 51 provided with a screw lid 52. On the screw lid 52 there is a pipe socket 53. By means of this pipe socket a connection to the connecting socket 12 of the valve screwdriver shown in FIG. 2 can be established through a hose. As a result of the container configuration and the simple handling, there is the possibility to connect the valve screwdriver with the container 40 even at inaccessible locations. For supplying compressed air, on the container 50 at the bottom side a valve 55 is provided. For supplying the sealing liquid into the valve screwdriver, it is of course required to slant or tilt the container such that the liquid can flow out through the pipe socket 53. In this configuration, the connecting sockets are initially connected to a metal plate that must be punctured.

FIG. 7 shows only a variant of the container illustrated in FIG. 5. Same parts are provided with the same reference numerals. The connecting socket 55a for supplying compressed air is arranged within the screw lid and extends partially parallel to the discharge socket or connector 43. In this embodiment, the connectors are also protected before initial operation by a metal plate closure.

FIG. 8a shows a device for supplying sealing liquid that is in the form of a valve insert driver 70 in a configuration that is already disclosed similarly in FIG. 1. It is comprised of a first pipe 71 and an extension member 72. Of course, both components can also be provided as a single component. Within the pipe 71 and the extension member 72, there is a rod 73 that has at its right end a turning grip 74 and at its left end a receptacle 75 for a tire valve. On the pipe 71 the connector 76 for filling the tire with sealing liquid is provided. For opening a valve on a tire, by means of the turning grip 74 this valve is unscrewed and the rod 73 is removed at the right side. The valve 77 is located on the rod. By means of the connector 76 the sealing liquid or the sealing medium can be introduced into a tire, not illustrated. On the extension member 72 at the left end there is an inner thread 78 that is screwed onto a valve of a tire. In the connecting area between the extension member 72 and the pipe 71 the extension member is provided with a reinforced area 72a so that bending is prevented.

FIG. 9 shows a further variant of the valve insert driver illustrated in FIG. 8. On the extension member 72 there is so-called plug-in nipple lever 79. It is attached to the thread 78 of the extension member 72. This plug-in nipple lever has a conventional configuration and is modified in that the inner pin that normally pushes a valve insert inwardly has been removed. In this way, the flow of the tire sealing medium is improved. In order for the tire sealing medium to be introducible into a tire, the valve insert must however be removed from the tire.

To the connector 76 a plug-in nipple lever can be attached. This plug-in nipple lever 80 is provided with a further connector 81 for attaching a supply pipe for the sealing medium thereto. The plug-in nipple lever 80 is pushed onto the connector 76 and is secured thereat by flipping the lever 82.

FIG. 8 as well as FIG. 9 shows a valve insert driver that is especially well suited for reaching, in the case of twin tires of commercial vehicles, the inner one of the twin tires without having to remove the outer tire. In the past it has been a big problem to fill the inner tire with sealing medium because a very great distance between the rim of the outer tire and the valve connector of the inner tire had to be bridged. This is now made possible with the solution according to FIG. 8.

Moreover, it has been a problem in the part to remove on outer twin tires the valve insert and to fill it with a sealing medium because the valve neck points to the rear. In conventional valve insert drivers the valve insert can drop in certain situations or can get lost.

By employing a plug-in nipple lever it is now possible to fill a valve neck that points to the rear with the sealing medium, i.e., it can be connected to the valve insert driver.

The valve insert driver illustrated in FIG. 8, as already mentioned, is passed through the spoke or rim opening of the outer twin tire to the valve neck of the inner twin tire and is screwed on to it by means of a standardized thread until it is seated securely on the valve neck. When using a plug-in nipple lever as shown in FIG. 9, the valve insert must be removed, of course, before filling with the sealing medium.

A variant of a suitable device for removing the valve insert is shown in FIG. 10 and FIG. 11, respectively.

In FIG. 10, a valve insert driver is shown that has a sleeve 83 that is provided with a lever 84. Within this sleeve there is clamping device 85 for clamping a valve which is to be unscrewed by means of the device. The sleeve 83 serves for fixation of the valve insert driver on the valve and protects at the same time the thread of the valve from damage. The sleeve 83 is rotatable relative to the lever 84 and can therefore be reliably held by the lever upon unscrewing a valve insert.

FIG. 11 shows a variant in a section illustration. Illustrated is a miniature valve insert driver. It serves for safely unscrewing a valve insert at locations that are hardly accessible, in particular, on outer twin tires. The valve insert driver encloses the end of the valve neck and thus prevents slipping off. By applying slight pressure, the valve insert locks on the clamping device 87 of the valve insert and is thus secured and protected from being lost.

Now, the sealing medium bottle can be connected directly to the open valve neck for filling the tire. After filling, the valve insert is again screwed in and the compressed air is filled in as is conventional.

Basically, there is also the possibility to connect the sealing medium bottle directly to an open valve neck without using a valve insert driver according to FIGS. 1, 8, or 9 in order to fill in the sealing medium. After the sealing medium has been filled in, by means of a valve insert driver, as illustrated in FIGS. 10 and 11, the valve is again screwed in and the tire is filled with air.

What is claimed is:

1.-18. (canceled)

19. A device for supplying sealing liquid into a tire, the device comprising:
a connecting flange that can be attached to a valve of a tire;
an essentially cylindrical housing arranged on the connecting flange, wherein the cylindrical housing has a connector for supplying the sealing liquid and a hollow space extending at least from the connector to the connecting flange;
a valve screwdriver arranged in the cylindrical housing so as to be movable in an axial direction of the cylindrical housing, wherein the valve screwdriver has a receptacle for detachably connecting the valve screwdriver to a valve insert of the valve of the tire such that the valve insert is removable by the valve screwdriver in the axial direction when the sealing liquid is to be supplied into the tire;
wherein the device for supplying the sealing liquid as a whole has an ergonomic and essentially elongate cylindrical shape.

20. The device according to claim 19, wherein the receptacle of the valve screwdriver has a clamping function for engaging differently designed valve inserts.

21. The device according to claim 19, further comprising a plug-in nipple lever attached to the valve screwdriver or to the connector of the cylindrical housing.

22. The device according to claim 19, wherein the connector for supplying the sealing liquid is arranged in a flow direction of the sealing liquid such that a deflection of the sealing liquid by less than 45 degrees takes place.

23. The device according to claim 19, wherein the connecting flange has a locking connection with a locking element that, by spring pressure, is attachable to the valve by engaging an outer thread of the valve.

24. The device according to claim 19, wherein on the cylindrical housing an extension member is provided for bridging a distance between the valve of the tire and the connector.

25. The device according to claim 19, wherein the valve screwdriver has a turning grip that is arranged axially movable on the cylindrical housing.

26. The device according to claim 19, further comprising a sealing liquid container provided with a hose, wherein the connector is connected to the hose that is in communication with the sealing liquid container, wherein the sealing liquid container has a connector for supplying compressed air, and wherein a receptacle for receiving the hose and the cylindrical housing with the connecting flange and the valve screwdriver is provided on an outer structure of the sealing liquid container.

27. The device according to claim 26, wherein the receptacle has a locking connection or a plug-in connection.

28. The device according to claim 27, wherein the sealing liquid container on at least one exterior side has devices for detachably attaching the sealing liquid container in or on a vehicle.

29. The device according to claim 26, wherein a check valve is provided in a supply conduit of the sealing liquid to the cylindrical housing.

30. The device according to claim 26, wherein at least one connector on the sealing liquid container is closed off by a puncturable metal plate.

31. A device for supplying sealing liquid into a tire, the device comprising: a connecting flange that is attachable to a valve of a tire, wherein the connecting flange is directly or indirectly connected to a sealing liquid container containing the sealing liquid;
wherein the sealing liquid container has a substantially cylindrical shape;
wherein the sealing liquid container has an opening closed off by a screw lid;
a discharging device comprising an immersion pipe extending to a bottom of the sealing liquid container or comprising a pipe arranged axially slidable in the screw lid.

32. The device according to claim 31, wherein the immersion pipe is provided for supplying compressed air or for discharging liquid.

33. The device according to claim 32, wherein the immersion pipe has a check valve in the form of a ball or a cylindrical closing member.

34. The device according to claim 31, wherein the immersion pipe for discharging the sealing liquid is provided on the screw lid and a valve for supplying compressed air is provided on a side of the container opposite the screw lid.

35. The device according to claim 31, wherein on the screw lid a valve or a connector for supplying compressed air is provided.

36. A valve insert driver comprising:
a screw sleeve or a cylindrical housing with a clamping device for receiving a valve of a tire; and
a manual actuating device.
